(19) United States
(12) Patent Application Publication
(10) Pub. No.: US 2019/0357744 A1
(43) Pub. Date: Nov. 28, 2019

(54) Cylinder Vacuum Cleaner

(71) Applicant: Eurofilters Holding N.V., Overpelt (BE)

(72) Inventors: Ralf Sauer, Overpelt (BE); Jan Schultink, Overpelt (BE)

(73) Assignee: Eurofilters Holding N.V., Overpelt (BE)

(21) Appl. No.: 16/479,396

(22) PCT Filed: Dec. 4, 2017
(86) PCT No.: PCT/EP17/81356

§ 371 Date: Jul. 19, 2019

(30) Foreign Application Priority Data
Jan. 31, 2017 (EP) 17153952.1

(51) Int. Cl. A47L 9/14; A47L 5/36; B01D 46/02; B01D 46/00

(52) U.S. Cl. CPC A47L 9/1427; A47L 5/362; B01D 2279/55; B01D 46/0005; B01D 46/02

(57) ABSTRACT

The present invention provides a floor vacuum cleaner, comprising a dust collecting unit supported on rollers and/or skids and including a motor fan unit, wherein the dust collecting unit comprises a housing having provided therein a dust chamber for accommodating a filter bag and a fan chamber for accommodating the motor fan unit, wherein the fan chamber containing the motor fan unit is arranged side by side with the dust chamber, the dust chamber and the fan chamber being separated from one another by a partition, wherein the dust chamber is fluidically connected to the fan chamber via a suction duct, wherein the suction duct is arranged such that, by means of the motor fan unit, air can be sucked upwards from the dust chamber, through the suction duct, into the fan chamber.

The present invention relates to a floor vacuum cleaner comprising a dust collecting unit supported on rollers and/or skids and including a motor fan unit.

In the case of vacuum cleaners, considerable efforts to improve the constancy of suction performance have been made in the last few years. In the case of bag vacuum cleaners, i.e. vacuum cleaners in which the sucked-in dust is separated in filter bags, such improvements can be accomplished by modifying the vacuum cleaner filter bag or the vacuum cleaner as such.

As regards vacuum cleaner filter bags, e.g. the filter materials used and the structure of the bag wall were changed. Teachings to this effect are disclosed in EP 0 960 645, EP 1 960 084, EP 2 263 508 or EP 2 366 319.

In the field of bag vacuum cleaners various types are differentiated. In addition to floor vacuum cleaners (sled vacuum cleaners) there are also upright vacuum cleaners, canister vacuum cleaners and stick vacuum cleaners. Improvements in the constancy of suction performance by modifying the bag vacuum cleaners are often based on a redesign of the dust collection chamber in which the vacuum cleaner filter bag is arranged during operation. Respective suggestions are disclosed e.g. in WO 2010/018086, EP 2 613 682, EP 2 465 399, WO 2010/067053, WO 2010/018089, DE 4014219, EP 2 236 072, EP 2 229 859 or EP 2 454 982.

In spite of all the efforts made, the suction performance constancy of known bag vacuum cleaners, in particular that of floor vacuum cleaners, is not yet satisfactory. When 400 g of DMT 8 dust are sucked in, this will typically still lead to a significant decrease in the measured volume flow of up to 30%.

Taking into account the above, it is the object of the present invention to provide a floor vacuum cleaner with an improved suction performance constancy. This object is achieved by the subject matter of claim 1.

According to the present invention, a floor vacuum cleaner is provided, which comprises a dust collecting unit supported on rollers and/or skids and including a motor fan unit,

wherein the dust collecting unit comprises a housing having provided therein a dust chamber for accommodating a filter bag and a fan chamber for accommodating the motor fan unit,

wherein the fan chamber containing the motor fan unit is arranged side by side with the dust chamber,

wherein the dust chamber and the fan chamber are separated from one another by a partition,

wherein the dust chamber is fluidically connected to the fan chamber via a suction duct,

wherein the suction duct is arranged such that, by means of the motor fan unit, air can be sucked upwards from the dust chamber, through the suction duct, into the fan chamber.

Surprisingly enough, it out turned out that a floor vacuum cleaner having this kind of structural design has an excellent suction performance constancy and is also handy and easy to move. The specific arrangement of the dust chamber and of the fan chamber as well as of the suction duct fluidically connecting the two chambers has the effect that the dust sucked into the bag during suction operation will predominantly be moved upwards, together with the suction air current, in a direction opposite to the gravitational direction. This dust is then (at least partially) separated and deposited at, and in, the area of the bag wall of the vacuum cleaner filter bag by which the interior of the vacuum cleaner filter bag is delimited at the top, when the vacuum cleaner filter bag has been installed in the vacuum cleaner. Due to the force of gravity, at least part of the dust separated in this area will drop within the bag, when the motor fan unit has been switched off, whereby the tendency of the bag wall to clog will be reduced.

Since, in addition, the fan chamber used for accommodating the motor fan unit is arranged side by side with the dust chamber (and not on top or above the latter), and since this results in low/low level positioning of the motor fan unit, the floor vacuum cleaner has a low center of gravity and can thus be moved in a stable manner and without much effort.

This configuration also results in a compact structural design so that the floor vacuum cleaner can easily be used even under space-restricted conditions. The fan chamber may be arranged substantially on the same level as the dust chamber.

Here and in the following, information such as “above” and “below” refer to the floor vacuum cleaner as arranged in intended use and suction operation, i.e. when it is supported on its rollers or skids.

Due to the configuration according to the claims, the suction duct opens into the dust chamber from above on the dust chamber side. The dust-chamber-side mouth area of the suction duct is arranged such that, during intended use, it will be positioned on top of and/or above the vacuum cleaner filter bag in the dust chamber.

The partition may be flat and straight or curved. In intended use, it may be arranged substantially vertically or at an angle to the vertical direction.

In the case of the above described floor vacuum cleaners, the dust chamber may be delimited by a boundary wall (top) on the upper side thereof. This (upper) boundary wall may be straight or curved. Such a boundary wall may have provided thereon a spacer so as to keep a filter bag, arranged in the dust chamber, in spaced-apart relationship with the boundary wall, when the floor vacuum cleaner is in operation.

By means of such a spacer it can advantageously be ensured that, even during suction operation, the air will be sucked upwards from the dust chamber, through the suction duct, into the fan chamber; contacting between part of the bag wall and the (upper) boundary wall, which would lead to clogging or blocking of the suction duct, is avoided.

The spacer may be configured in the form of ribs and/or a grid. The ribs and/or the grid may be secured to the upper boundary wall (top) of the dust chamber. The ribs may be rod-shaped or flat.

The suction duct may be delimited, at least partially, by the (upper) boundary wall. The suction duct may, at least partially, in particular the part located within the suction chamber, extend along the upper boundary wall.

Between the boundary wall and the partition an opening may be formed through which the suction duct extends. The dust chamber and the partition are thus configured such that (in intended use) air is sucked from the dust chamber across the partition into the fan chamber and into the motor fan unit. According to this embodiment, the air path across the partition is the shortest fluidic connection between the dust chamber and the fan chamber/motor fan unit; there is no other or shorter connection (e.g. through an opening in the middle of the partition, this kind of opening being typically provided in the case of conventional floor vacuum cleaners).

Instead of an opening formed between the partition and the boundary wall, the partition may alternatively have in its upper area an opening through which the suction duct extends from the dust chamber into the fan chamber. This kind of opening in the partition is possible as long as it can be ensured that the suction duct has a configuration of a nature guaranteeing that the air will be sucked upwards within the dust chamber. According to this alternative, the partition may also be configured as a continuous component up to the boundary wall, i.e. it may directly adjoin the boundary wall (without any intermediate opening).

The dust chamber may be delimited by opposed sidewalls in a direction transversely to the partition, the suction duct extending, at least partially, along one or both sidewalls. According to this configuration, the opposed sidewalls adjoin the partition; in an upward direction, the sidewalls adjoin the (upper) boundary wall/top. This kind of structural design extends the mouth area of the suction duct towards one or both sidewalls; hence, it is no longer limited to the boundary wall. This leads to an increase in the bag wall area through which the air current carrying the dust is sucked out of the vacuum cleaner filter bag. This also leads to an increase in the area of the bag wall and its filter material, respectively, where dust is separated and deposited, which leads to a further reduction of the tendency to clog and thus to a longer unchanging suction performance constancy.

Alternatively or additionally, the dust collection chamber may be delimited by an end wall located opposite the partition, the suction duct extending, at least partially, along the end wall. The above-mentioned opposed sidewalls will then adjoin the partition on one side and the end wall on the respective other side.

The end wall may be arranged, at least partially, parallel to the partition. It may, however, also be inclined relative to the partition. The end wall itself may in particular be flat and straight or curved. When the floor vacuum cleaner is used as intended, the end wall may be arranged, at least partially, substantially vertically or at an angle to the vertical direction. The end wall may adjoin, on the upper side thereof, the boundary wall/top.

Due to the fact that the suction duct, in particular the mouth area thereof, extends, at least partially, along the end wall, the separation area of the filter material of the bag wall is increased still further, and this leads to a further reduction of the tendency to clog.

Alternatively, the suction duct may be arranged such that, by means of the motor fan unit, air can exclusively be sucked upwards from the dust chamber, through the suction duct, into the fan chamber. This means that, in this embodiment, the suction duct is delimited and sealed off, respectively, towards the sidewalls and/or the end wall; the mouth area of the suction duct is thus limited to the boundary wall/top, i.e. it is exclusively located above the vacuum cleaner filter bag during operation. This configuration leads to a higher volume flow in the suction duct, and a large part of the dust chamber is available for the vacuum cleaner filter bag.

In the above described floor vacuum cleaners, one or both sidewalls, the partition and/or the end wall may have spacers arranged thereon, so as to keep a filter bag, arranged in the dust chamber, in spaced-apart relationship with the respective sidewall, partition and/or end wall. This also ensures, during suction operation, that the suction air can pass through the respective area of the bag wall and that dust will be separated at this surface on the inner side of the vacuum cleaner filter bag.

The motor fan unit may be arranged such that air sucked in via the suction duct enters the motor fan unit from above. This avoids unnecessary deflection of the sucked-in air and allows a high volume flow to be achieved even at low motor output. The suction duct may here open into the fan chamber from above; the fan-chamber-side mouth is arranged above the fan chamber.

The dust chamber may be delimited by a boundary wall on the upper side thereof, the boundary wall being configured, at least partially, as an openable and closable, in particular pivotable, cover. This means that (at least partially) also the suction duct as well as the mouth area thereof are formed in the area of the cover of the vacuum cleaner. In particular, also the above described features relating to the boundary wall, e.g. the spacer provided thereon, may then be realized on the cover. It follows that, according to this embodiment, air is sucked from the dust chamber in the direction of the cover and is conducted into the fan chamber through the suction duct, which, at least partially, extends along the cover.

In the case of the above described vacuum cleaners, the dust chamber may be delimited on the upper side thereof by a boundary wall having provided therein an inlet opening for an air current to be sucked in. Alternatively, the dust chamber may be delimited by an end wall located opposite the partition and having provided therein an inlet opening for an air current to be sucked in. The sucked-in air enters the dust chamber through this inlet opening, at which the suction piece of the vacuum cleaner is arranged. Then, the sucked-in air is conducted through the suction piece into a vacuum cleaner filter bag arranged in the dust chamber; in the vacuum cleaner filter bag, the sucked-in dust is separated. The (upper) boundary wall or the end wall located opposite the partition may be configured (at least partially) as an openable and closable, in particular pivotable, cover. This means that the inlet opening—and optionally a connection piece which may be provided on the inlet opening and which protrudes into the interior of the dust chamber—is/are arranged in the cover of the floor vacuum cleaner, especially of the dust chamber.

The above described floor vacuum cleaners may comprise a suction hose, a suction tube and a floor nozzle, wherein air can be sucked through the floor nozzle, the suction tube and the suction hose into the dust chamber by means of the motor fan unit. The air may enter the dust chamber through a connection piece protruding into the dust chamber. This kind of connection piece protrudes into and enters a holding plate of the vacuum cleaner filter bag and/or the interior of the vacuum cleaner filter bag itself.

The floor vacuum cleaner may further comprise a holder arranged within the dust chamber and used for holding a filter bag. The holder may in particular be configured for receiving therein and holding a holding plate of a vacuum cleaner filter bag.

The vacuum cleaner filter bag may be a flat bag or it may have a block-bottom shape. A flat bag is defined by two sidewalls of filter material, which are connected to one another along their peripheral edges (e.g. by means of welding or bonding). One of the two sidewalls may have provided therein the bag filling opening or inlet opening. The lateral surfaces or sidewalls may each have a rectangular basic shape. Each sidewall may comprise one or a plurality of layers of a non-woven and/or of a nonwoven fabric.

The suction duct is typically delimited on one side thereof by the upper boundary wall of the dust chamber and the cover, respectively. In the direction of the sidewalls delimiting the dust chamber, the suction duct may be open or closed. In the direction of an end wall, which is located opposite the partition and which also delimits the dust chamber, the suction duct may be open or closed. In the direction of the dust chamber, the suction duct is defined or delimited in particular by a spacer. In this way, the dust-chamber-side mouth of the suction duct is defined or formed.

The above described vacuum cleaners may further comprise a motor protection filter arranged at the fan-chamber-side mouth of the suction duct. This motor protection filter prevents particles, which may perhaps escape from the bag, from being sucked into and damaging the motor fan unit.

The motor fan unit may comprise an axial fan, in particular a single-stage axial fan. In the case of an axial fan, the air is sucked in parallel or axially to the drive axis of the impeller and blown out parallel or axially to the drive axis.

The axis of rotation of the axial fan may be oriented perpendicular to or at an angle of not more than 60°, in particular not more than 45°, to the vertical direction during operation of the floor vacuum cleaner. In this way, the air current can advantageously be sucked in through the suction duct.

Further features and advantages are described making reference to the figures, in which

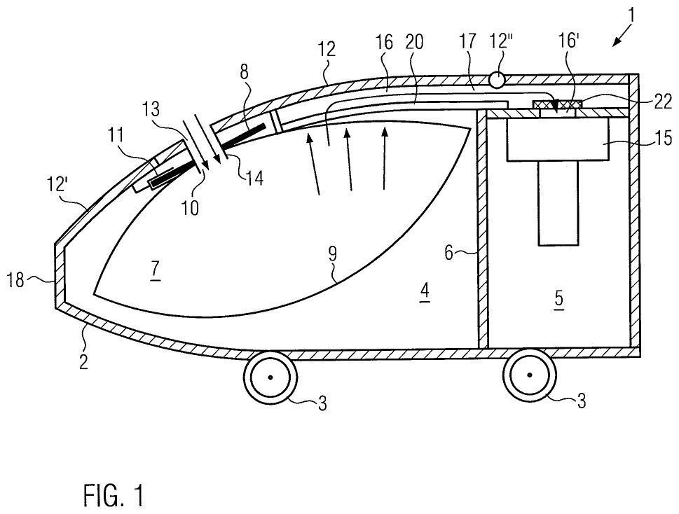

FIG. 1 shows a schematic cross-sectional view of a floor vacuum cleaner;

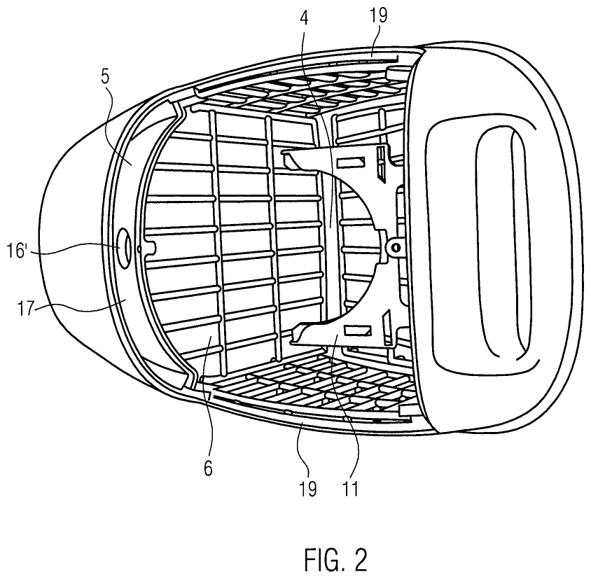

FIG. 2 shows a schematic interior view of a floor vacuum cleaner;

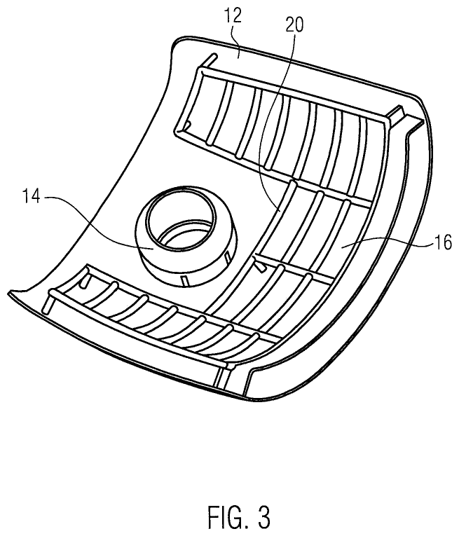

FIG. 3 shows a schematic top view of the inner side of a cover of a floor vacuum cleaner;

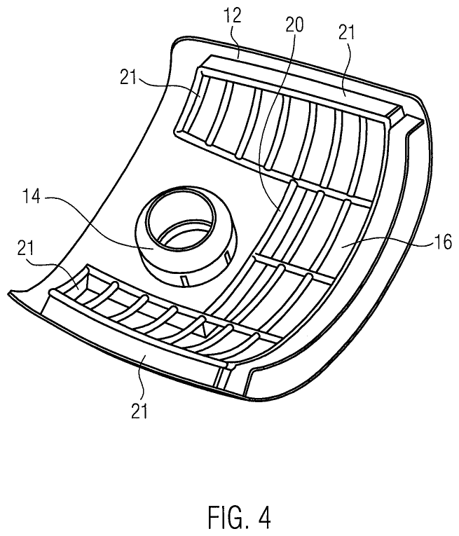

FIG. 4 shows schematically a top view of the inner side of a further cover of a floor vacuum cleaner;

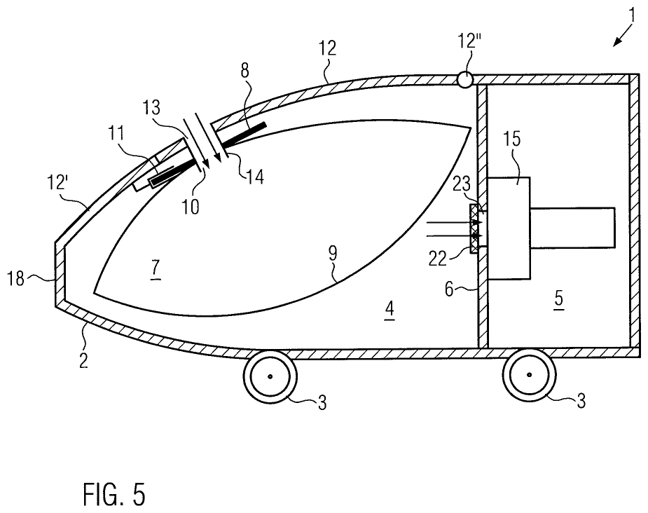

FIG. 5 shows a schematic cross-sectional view of a comparative floor vacuum cleaner.

FIG. 1 shows schematically a floor vacuum cleaner 1 with a dust collecting unit 2 which, in the example shown, is supported on rollers 3.

The housing of the dust collecting unit 2 has provided therein a dust chamber 3 and a fan chamber 4. The dust chamber 4 and the fan chamber 5 are arranged side by side and are separated from each other by a partition 6. The fan chamber 5 is located on the same level as the dust chamber 4, i.e. it is in particular not arranged above the dust chamber. This allows a low centre of gravity and a compact structural design.

The dust chamber 4 has provided therein a vacuum cleaner filter bag 7, which, in the example shown, is a flat bag. The vacuum cleaner filter bag 7 comprises a bag wall 9 consisting of a single-layer or a multi-layer filter material. The one or the plurality of layers of filter material may in particular each consist of a nonwoven and/or a non-woven fabric.

The bag wall 9 has a holding plate 8 secured thereto, which is e.g. welded to the filter material. The holding plate 8 is arranged at the bag filling opening or inlet opening 10 of the vacuum cleaner filter bag and has a passage opening of its own.

The holding plate 8 is taken up by a holder 11 by means of which the vacuum cleaner filter bag 7 is held in the dust chamber 4.

The dust chamber 4 is, on the upper side thereof, delimited by an (upper) boundary wall, which is configured as a bipartite component in the present example. It comprises a cover 12, which is pivotable about a hinge 12″. In this way, the dust chamber 4 can be opened to insert or remove a vacuum cleaner filter bag. The boundary wall additionally comprises a stationary portion 12′, which adjoins an end wall 18.

The cover 12 has provided therein an inlet opening 13 for an air current to be sucked in. The inlet opening 13 has arranged thereon a suction piece 14, which is typically fixedly connected to the upper boundary wall, i.e. here to the cover 12.

In the inserted condition of the vacuum cleaner filter bag 7, the suction piece 14 enters the bag filling opening 10 of the vacuum cleaner filter bag after the cover has been closed, so that the sucked-in air will be sucked through the cover 12 and through the suction piece 14 into the vacuum cleaner filter bag 7.

The suction air-current is produced by a motor fan unit 15, which is arranged in the fan chamber 5. The motor fan unit may in particular be an axial fan.

At the cover 12 and thus at the upper boundary wall of the dust chamber 4, a suction duct 16 is provided. This suction duct 16 fluidically connects the dust chamber 4 to the fan chamber 5. In other words, the air sucked in by the motor fan unit 15 flows through the suction duct 16 into the fan chamber 5 after having entered—as indicted by the arrows—the vacuum cleaner filter bag 7 through the inlet opening 13 in the cover 12 and the connection piece 14.

The partition 6 separates the dust chamber 4 and the fan chamber 5 from one another in such a way that, apart from the suction duct 16, there is no other fluidic connection between the dust chamber 4 and the fan chamber 5. In this way, the air sucked in through the motor fan unit 15 is sucked upwards within the dust chamber 4 and in particular within the vacuum cleaner filter bag 7 in the direction of the upper boundary wall and the cover 12 and flows then through the suction duct 16 into the fan chamber 5. Between the upper boundary wall of the dust chamber (in particular of the cover 12) and the partition 6 an opening 17 is formed, through which the suction duct leads into the fan chamber 5. The suction duct 16 thus extends along the upper boundary wall of the dust chamber 4 through the opening 17 to above the fan chamber 5, into which it opens from above through the mouth 16′. The mouth 16′ has arranged thereon a motor protection filter 22, which is supported by a suitable holder.

On the basis of this configuration, dust sucked into the vacuum cleaner filter bag 7 is separated predominantly at the area of the bag wall 9 located adjacent the suction duct 16 and the mouth of the latter in the dust chamber 14. This area of the bag wall 9 is arranged on the upper side of the installed bag. As soon as the motor fan unit 15 is switched off, at least part of the dust separated at the bag wall arranged at the top, when the vacuum cleaner is in operation, will drop downwards within the vacuum cleaner filter bag 7, so that early clogging of the filter material will be prevented.

The suction duct 16 is formed along the upper boundary wall of the dust chamber and along the cover 12, respectively, and extends therealong. In this way, also the air current is conducted from the dust chamber 4 along the upper boundary wall and the cover, respectively, in particular into the fan chamber 5.

The dust chamber is delimited by an end wall 18 located opposite the partition 6.

As will also be illustrated in the figures following hereinafter, the upper boundary wall and the cover 12, respectively, have spacers, so as to keep the vacuum cleaner filter bag 7 in spaced-apart relationship with the boundary wall. These spacers delimit, at least partially, the suction duct 16.

FIG. 2 is an interior view of a floor vacuum cleaner showing especially the dust chamber 4. The dust chamber 4 has provided therein the holder 11 for the holding plate of the vacuum cleaner filter bag. The partition 6 separates the dust chamber 4 from the fan chamber 5 located therebehind. The upper edge of the partition 6 defines, together with the cover 12 (i.e. the upper boundary wall) which is not shown in FIG. 2, an opening 17 through which the suction duct extends from the dust chamber 4 into an area above the fan chamber 5. Through the mouth 16′, an air current conducted along the suction duct enters the fan chamber arranged below the mouth 16′.

The dust chamber 4 is, transversely to the partition, delimited by two opposed sidewalls 19 adjoining each the partition 6 on a respective side. On the respective other side, they adjoin the end wall 18.

In the example illustrated in FIG. 2, spacers are arranged on the partition 6, on the sidewalls 19 and also on the base of the dust chamber 4. By means of these spacers, a filter bag arranged in the dust chamber 4 is kept in spaced-apart relationship with the respective walls.

FIG. 3 shows a top view of the inner side of a cover 12 defining the upper boundary wall of a dust chamber. The cover 12 has arranged thereon the connection piece 14 through which air can flow into the dust chamber. The cover 12 has additionally arranged thereon a grid 20, which defines a spacer. By means of this grid 20, a vacuum cleaner filter bag arranged within the dust chamber 4 is kept in spaced-apart relationship with the cover, i.e. the grid 20 prevents the bag from getting into contact with the cover in the switched-on condition of the motor fan unit.

The grid 20 defines (at least partially) a suction duct 16 extending along the cover 12 towards the dust chamber. By means of the arrangement of the grid 20 and of the thus defined suction duct as well as of the opening 17 defined between the partition 6 and the cover 12, it is guaranteed that sucked-in air will be sucked upwards within the dust chamber 4 towards the cover 12 and into the dust-chamber-side mouth of the suction duct and will then be conducted through the suction duct along the cover 12 through the opening 17. The suction duct extends into an area above the fan chamber 5 and ends in a mouth 16′ through which the air enters the fan chamber 5 and the motor fan unit 15 provided there. In particular, the partition 6, which has no other openings provided therein, prevents air from being sucked from the dust chamber 4 into the fan chamber 5 along some other, more direct path.

Instead of an opening 17 formed between the partition 6 and the cover 12, the partition 6 may, alternatively, also be configured as a continuous component up to the cover 12 (the upper boundary wall). In this case, the partition 6 then has in the upper area thereof an opening through which the suction duct extends from the dust chamber to the fan chamber. This kind of opening in the partition is possible as long as it can be ensured that the suction duct has a configuration of a nature guaranteeing that the air will be sucked upwards within the dust chamber.

In the embodiment shown in FIG. 3, the shown part of the suction duct 16 has a circumferentially open edge area. In this way, it will additionally be possible to suck in air in the direction of the two sidewalls 19, when the dust chamber has a configuration of the type shown in FIG. 2. Air sucked in in the direction of the sidewalls is conducted upwards along the sidewalls 19 in the direction of the upper boundary wall and, by means of the suction duct, through the opening 17 in the direction of the fan chamber 5.

An alternative embodiment is shown in FIG. 4. The here shown view of the inner side of a cover 12 with a connection piece 14 is again provided with a grid 20 by means of which a mouth area of the suction duct 16 is formed. However, in this embodiment, the shown part of the suction duct 16 has a circumferentially closed edge area. The suction duct is here provided with a boundary wall 21 especially in the direction of the two sidewalls, in the direction of the connection piece and in the direction of the end wall, so that the suction duct 16 is open only in the direction of the vacuum cleaner filter bag and in the direction of the base of the dust chamber through its mouth area.

In this way, the air in the dust chamber is exclusively sucked upwards into the dust-chamber-side mouth area of the suction duct 16; suction in the direction of one of the sidewalls does not take place. Also this configuration provides a surprisingly high suction performance constancy.

FIG. 5 illustrates a schematic cross-sectional view of a conventional floor vacuum cleaner, which has been used for a comparative test. The comparative vacuum cleaner has a conventional structural design, in the case of which the dust chamber 4 is separated from the fan chamber 5 by a partition 6. In the standard configuration illustrated, the partition 6 has provided therein a passage opening 23, which establishes a direct (and single) fluidic connection between the dust chamber 4 and the fan chamber 5; a suction duct of the type shown in FIG. 1 is, however, not provided.

In comparison with the solution according to the present invention shown in FIG. 1, the motor fan unit according to FIG. 5 has been rotated by 90° and sucks in air from the dust chamber 4 through the passage opening 23. In front of the passage opening, a motor protection filter 22 is arranged.

For comparative reasons, the suction performance constancy was measured with a floor vacuum cleaner according to the present invention (as illustrated in FIGS. 1, 2 and 4) and with a standard floor vacuum cleaner (as illustrated in FIG. 5). In so doing, the extent to which the volume flow decreases when DMT dust (type 8) is sucked in was determined.

The air data of the vacuum cleaner were determined in each case according to DIN EN 60312-1:2014-01. Reference is especially made to Section 5.8. The measuring equipment used is the equipment type B according to Section 7.3.7.3. For possibly necessary adapters for connection to the measurement chamber, the statements made in Section 7.3.7.1 apply. Also the terms “volume flow” and “suction air flow” will be used for the term “air current” according to DIN EN 60312-1.

In both floor vacuum cleaners a motor fan unit with a power consumption of 750 W was used. The dimensions and the geometry of the dust chamber were essentially the same in both cases. However, the conventional vacuum cleaner had no grid-shaped spacers on the base, the sides and the cover; the base had only provided thereon a few ribs. In the case of both floor vacuum cleaners, a conventional motor protection filter was arranged at the opening leading into the fan chamber 5 (i.e. at the mouth 16′ and the passage opening 22, respectively). In both cases, the same original OEM vacuum cleaner filter bag of the standard floor vacuum cleaner was used.

The volume flow was determined with the bag inserted but empty, after 200 g of DMT 8 dust and 400 g of DMT 8 dust had been sucked in. The percentage decrease in volume flow is shown in the table below.

| | decrease in | decrease in |
|---|---|---|
| | volume flow after | volume flow after |
| | 200 g DMT 8 | 400 g DMT 8 |
| floor vacuum cleaner | 1.0% | 4.4% |
| according to the present | | |
| invention, cover as shown | | |
| in FIG. 4 | | |
| conventional floor vacuum | 4.2% | 11.2% |
| cleaner as shown in FIG. 5 | | |

It is readily evident that the configuration according to the present invention, where the air is sucked into the fan chamber via a suction duct 16 arranged in the way described above, leads to a significant improvement of suction performance constancy. Even when 400 g of dust have been sucked in, the decrease in volume flow is still less than 5% in the case of the present invention.

1. A floor vacuum cleaner comprising a dust collecting unit supported on rollers or skids and including a motor fan unit,
wherein the dust collecting unit comprises a housing having provided therein a dust chamber for accommodating a filter bag and a fan chamber for accommodating the motor fan unit,
wherein the fan chamber containing the motor fan unit is arranged side by side with the dust chamber,
wherein the dust chamber and the fan chamber are separated from one another by a partition,
wherein the dust chamber is fluidically connected to the fan chamber via a suction duct,
wherein the suction duct is arranged such that air can be sucked upwards from the dust chamber, through the suction duct, into the fan chamber by the motor fan unit.

2. The floor vacuum cleaner according to claim 1, wherein the partition comprises an opening through which the suction duct extends.

3. The floor vacuum cleaner according to claim 1, wherein the dust chamber is closed by a boundary wall on an upper side of the dust chamber, and an opening, through which the suction duct extends, is formed between the boundary wall and the partition.

4. The floor vacuum cleaner according to claim 1, wherein the dust chamber is delimited by a boundary wall on the upper side of the dust chamber and the boundary wall has provided thereon spacers to keep a filter bag, arranged in the dust chamber, in spaced-apart relationship with the boundary wall, when the floor vacuum cleaner is in operation.

5. The floor vacuum cleaner according to claim 4, wherein the spacers are configured in the form of ribs or a grid.

6. The floor vacuum cleaner according to claim 1, wherein the dust chamber is delimited by opposed sidewalls in a direction transverse to the partition, the suction duct extending, at least partially, along one or both sidewalls.

7. The floor vacuum cleaner according to claim 1, wherein the dust chamber is delimited by an end wall located opposite the partition, the suction duct extending, at least partially, along the end wall.

8. The floor vacuum cleaner according to claim 1, wherein the suction duct is arranged such that, air can exclusively be sucked upwards from the dust chamber, through the suction duct, into the fan chamber by the motor fan unit.

9. The floor vacuum cleaner according to claim 1, wherein one or both sidewalls, the partition or the end wall have spacers arranged thereon, to keep a filter bag, arranged in the dust chamber, in spaced-apart relationship with the respective sidewall, partition or end wall.

10. The floor vacuum cleaner according to claim 1, wherein the motor fan unit is arranged such that air sucked in via the suction duct enters the motor fan unit from above.

11. The floor vacuum cleaner according to claim 1, wherein the dust chamber is delimited by a boundary wall on the upper side thereof, the boundary wall being configured, at least partially, as an openable and closable cover.

12. The floor vacuum cleaner according to claim 1, wherein the dust chamber
is delimited on the upper side of the dust chamber by a boundary wall having provided therein an inlet opening for an air current to be sucked in, or
is delimited by an end wall located opposite the partition and having provided therein an inlet opening for an air current to be sucked in.

13. The floor vacuum cleaner according to claim 1, comprising a suction hose, a suction tube and a floor nozzle, wherein air can be sucked into the dust chamber through the floor nozzle, the suction tube and the suction hose by the motor fan unit.

14. The floor vacuum cleaner according to claim 1, comprising a holder arranged within the dust chamber and used for holding a filter bag.

15. The floor vacuum cleaner according to claim 1, comprising a motor protection filter arranged at a fan-chamber-side mouth of the suction duct.

16. The floor vacuum cleaner according to claim 11, wherein the cover is pivotable.
